(19) United States
(12) Patent Application Publication
(10) Pub. No.: US 2010/0162011 A1
(43) Pub. Date: Jun. 24, 2010

(54) METHOD AND APPARATUS FOR CONTROLLING INTERRUPTS IN PORTABLE TERMINAL

(75) Inventor: Jang Ki MIN, Seoul (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/644,142

(22) Filed: Dec. 22, 2009

(30) Foreign Application Priority Data
Dec. 22, 2008 (KR) 10-2008-0131388

(51) Int. Cl. G06F 1/00

(52) U.S. Cl. 713/300

(57) ABSTRACT

An interrupt controlling method and apparatus is disclosed. The method and apparatus generates allows a connecting gate to output different signals according to whether charging electric power or communication electric power is supplied to the connector unit of the portable terminal and then outputs them to the power management IC. The power management IC performs a controlling operation in such a way that it can generate only a charging interrupt command if a travel adaptor is connected to the connector unit and generate a communication interrupt when the communication device is coupled to the connector unit.

### CLAIMS OF PRIORITY

This application claims priority to an application entitled “METHOD AND APPARATUS FOR CONTROLLING INTERRUPTS IN PORTABLE TERMINAL” filed in the Korean Intellectual Property Office on Dec. 22, 2008 and assigned Serial No. 10-2008-0131388, the contents of which are incorporated herein by reference.

### BACKGROUND OF THE INVENTION

1. Field of the Invention

The present invention relates to communication systems, and more particularly, to a method and apparatus that controls the operation modes in a portable terminal according to types of external devices.

2. Description of the Related Art

In recent years, portable terminals have been developed to store a variety of application programs for users which in turn led to a rapid increase in the number of terminal users and service subscribers.

In the early stage, conventional portable terminals were relatively heavy and large in weight and size in order to stabilize the battery and electronic parts installed therein. They have recently been reduced in weight, size, and thickness as technology related to electronic parts and batteries has been upgraded.

A portable terminal is typically provided with a travel adapter to recharge its battery and a cable to support USB communication. However, since a conventional connector interface unit of the portable terminal supports the same port for these two devices, thus causing interruptions whenever the terminal is connected to external devices. That is, although a travel adaptor is connected to the connector interface unit, an interrupt for USB communication occurs. Similarly, when a cable for USB communication is connected to the connector interface unit, an interrupt for a travel adapter also occurs.

### SUMMARY OF THE INVENTION

The present invention has been made in view of the above problems, and provides a method and apparatus that can control the occurrence of interrupts in a portable terminal according to external devices types.

In accordance with an exemplary embodiment of the present invention, the present invention provides a method for controlling interrupts in a portable terminal, including: connecting a travel adaptor for supplying a charging electric power or a communication device for supplying an electric power to a connector unit of the portable terminal; generating an output signal in a connecting gate, according to the charging electric power or the communication electric power; and generating a charging interrupt or a communication interrupt in a power management IC according to the generated output signal.

In accordance with another exemplary embodiment of the present invention, the present invention provides an apparatus for controlling interrupts in a portable terminal, including: a connector unit connectable to a travel adaptor for supplying and charging electric power or a communication device for supplying a communication electric power; a connecting gate for generating an output signal according to the charging electric power or the communication electric power; and a power management IC for generating a charging interrupt or a communication interrupt according to the generated output signal.

### BRIEF DESCRIPTION OF THE DRAWINGS

The features and advantages of the present invention will become more apparent from the following detailed description in conjunction with the accompanying drawings, in which:

FIG. 1 is a view illustrating a portable terminal and an external device that is connectable to a connecting unit of the portable terminal, according to an embodiment of the present invention;

FIG. 2 is a schematic block diagram illustrating a portable terminal according to an embodiment of the present invention;

FIG. 3 is a detailed view illustrating a connecting gate and a power management IC according to an embodiment of the present invention;

FIG. 4 is a view that describes a signal flow when a travel adapter is connected to the portable terminal according to an embodiment of the present invention;

FIG. 5 is a view that describes a signal flow when a communication device is connected to the portable terminal according to an embodiment of the present invention; and

FIG. 6 is a flow chart that describes a method for controlling interrupts in the portable terminal according to an embodiment of the present invention.

### DETAILED DESCRIPTION OF THE INVENTION

Hereinafter, exemplary embodiments of the present invention are described in detail with reference to the accompanying drawings. The same reference numbers are used throughout the drawings to refer to the same or similar parts. For the purposes of clarity and simplicity, detailed descriptions of well-known functions and structures incorporated herein may be omitted to avoid obscuring the subject matter of the present invention.

Note that the terms or words described in the present description and the claims should not be limited by a general or lexical meaning, instead should be analyzed as a meaning and a concept through which the inventor defines and describes the present invention at his most effort, to comply with the idea of the present invention. Therefore, one skilled in the art will understand that the embodiments disclosed in the description and configurations illustrated in the drawings are only preferred embodiments, instead there may be various modifications, alterations, and equivalents thereof to replace the embodiments at the time of filing this application.

For example, the external device, connectable to a connector unit of the portable terminal, is explained based on a travel adaptor and an external memory. It should be, however, understood that the external device and the method for controlling the device are not limited to the embodiment. That is, the external device and the controlling method thereof can be applied to a desktop computer, a laptop computer, a personal digital assistant (PDA), a garners, etc. It will be appreciated that the external device includes apparatus that can be connected to a connector unit of the portable terminal and supports a recharge mode where electric power is supplied to the battery of the portable terminal and also apparatus for supporting a communication mode that allows the portable terminal to perform communication.

In an embodiment of the present invention, although the portable terminal is explained based on a mobile communication terminal having an RF communication unit, it should be, however, understood that the present invention is not limited to the embodiment. That is, it will be appreciated that the portable terminal includes terminals that can allow for the connection of external devices and support corresponding functions of the external devices.

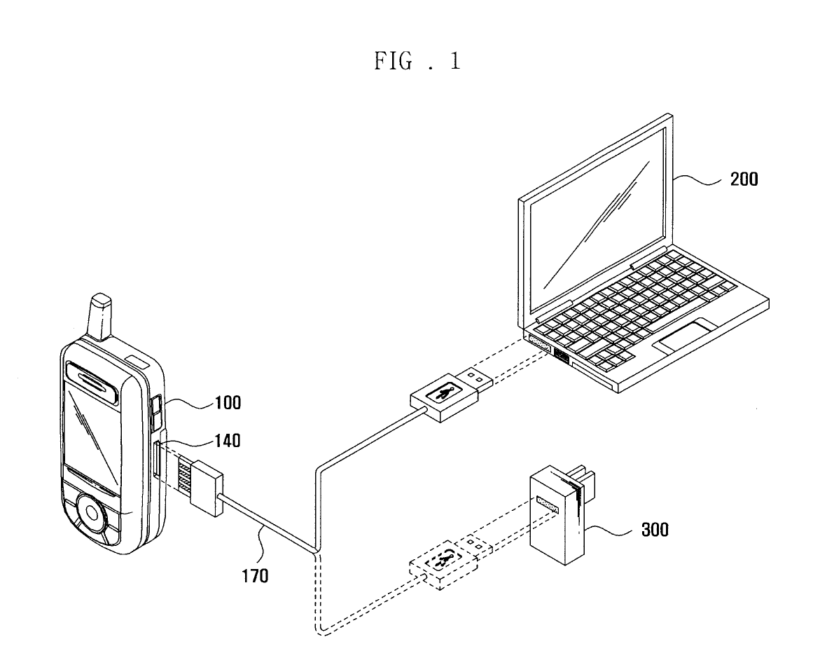

FIG. 1 is a view illustrating a portable terminal and an external device that is connectable to a connecting unit of the portable terminal according to an embodiment of the present invention. For illustrative purposes, the external device is a laptop computer 200 and a travel adapter 300.

Referring to FIG. 1, the portable terminal 100 is connected, via its connector unit 140, to the laptop computer 200 and the travel adaptor 300. In the embodiment of the present invention, the laptop computer 200 is disclosed as an example of the communication devices that can be communicated with the portable terminal 100. The travel adaptor 300 is also disclosed as an example of the charging devices that can recharge the battery of the portable terminal 100. The portable terminal 100 automatically switches between a recharging mode and a communication mode, according to the types of external devices connected thereto, and then performs a function corresponding to the switched mode. If the travel adaptor 300 is connected to the connector unit 140, the portable terminal 100 interrupts the communication link. If another device, such as a laptop computer 200, is connected to the connector unit 140, the portable terminal 100 interrupts the recharging.

More specifically, if an external device is a laptop computer 200, the portable terminal 100 activates a communication mode allowing for communication with the laptop computer 200 and reads out information stored in the laptop computer 200 or outputs information from the portable terminal 100 to the laptop computer 200 during operation. The laptop computer 200 may include a connection line, for example, a cable, which can be connected to the connector unit 140 of the portable terminal 100. When the connector unit 140 is connected to the laptop computer 200 via the cable, it receives power for communication, i.e., USB power, via the cable. While the USB power is being supplied through the connecting gate of the portable terminal 100, the USB power is converted by a controller of the terminal in such a way to transmit a connection signal to a communication interrupt port of the controller, and not to a recharging interrupt port of the controller. Thus, the terminal switches to a communication mode upon receiving the connection signal.

If an external device is a travel adaptor 300, the portable terminal 100 activates a recharging mode where the electrical power is supplied from the travel adaptor 300 to the battery so that the battery can be recharged under the control of the controller. The travel adaptor 300 is configured in such a way that its one end is connected to the connector unit 140 of the portable terminal 100 via the cable 170 and the other end is plugged in the receptacle, so that it supplies electrical power from the receptacle to the portable terminal 100. It will be appreciated that the travel adaptor 300 transforms a High voltage of commercial electrical power of the receptacle into a certain level of voltage for the portable terminal 100. In order to rapidly recharge a battery of the portable terminal 100, the travel adaptor 300 may supply electric power to the battery of the portable terminal 100 using a maximum rated current with an allowable margin to the portable terminal 100 and its battery. When the travel adaptor 300 is connected to the portable terminal 100, charging electric power, i.e., wall charger power, is transmitted to each signal line. Therefore, while the charging electric power is being supplied through the connecting gate, the charging electric power is converted by a controller of the terminal in such a way to transmit a connection signal to the recharging interrupt port of the controller and not to a communication interrupt port of the controller. As a result, the terminal executes a charging mode.

That is, the portable terminal 100 can convert a charging electric power or USB power through a connecting gate, so that a signal can be transmitted only to a port that needs interrupting, thereby preventing unnecessary interrupts from occurring and properly controlling an external device.

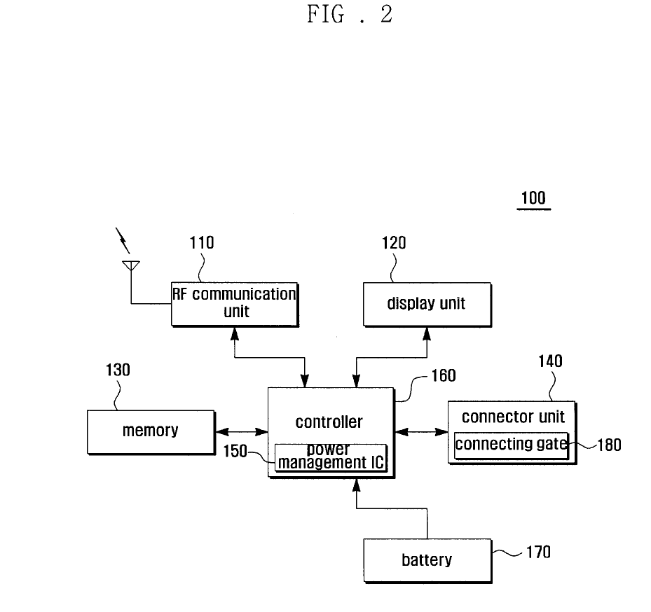

In the following description, a detailed description is provided regarding the configuration of the portable terminal 100 with reference to FIG. 2.

FIG. 2 is a schematic block diagram illustrating a portable terminal according to an embodiment of the present invention.

Referring to FIG. 2, the portable terminal 100 includes an RF communication unit 110, a display unit 120, a memory 130, a connector unit 140, a battery 170, and a controller 160. Note that the RF communication unit 110 may be omitted if the portable terminal 100 is implemented with devices other than a mobile communication terminal.

The RF communication unit 110 performs transmission and reception of signals related to the communication of a portable terminal, short message service (SMS) or multimedia message service (MMS), data communication, etc. The RF communication unit 110 converts voice/audio data and control data into RF signals and transmits them to other communication systems. Similarly, the RF communication unit 110 also receives RF signals, converts them to voice/audio data and control data, and then outputs them. To this end, the RF communication unit 110 is configured to include an RF transmitter for up-converting the frequency of transmitted signals and amplifying the transmitted signals and an RF receiver for low-noise amplifying received RF signals and down-converting the frequency of the received RF signals. When the travel adaptor 300 is connected to the connector unit 140, the RF communication unit 110 receives electric power directly from the travel adaptor 300 and is operated under the control of the controller 160. If a laptop computer 200 is connected to the connector unit 140, the RF communication unit 110 can wirelessly transmit information from the laptop computer 200 to the outside.

The display unit 120 can display video data from the controller 160. The display unit 120 can also display data requested by a user and screens corresponding to additional functions. The display unit 120 can display an idle screen, as a default screen, and a main menu of a portable terminal. The display unit 120 can display screens of a list of information stored in the memory 130. The display unit 120 may include an LCD, etc. The display unit 120 may be a touch screen and serve as an input device.

In the embodiment of the present invention, the display unit 120 can display a variety of screen interfaces according to types of external devices connected to the connector unit 140.

If the travel adaptor 300 is connected to the connector unit 140, the display unit 120 can display a pop-up message, showing that the travel adaptor 300 has been connected thereto for a certain period of time, or an image corresponding thereto. The display unit 120 can display, in real time, the remaining amount of battery while the travel adaptor 300 recharges the battery 170.

If the laptop computer 200 is connected to the connector unit 140, the display unit 120 can display a pop-up message, showing that the laptop computer 200 has been connected thereto, or an image corresponding thereto. The display unit 120 can display a list of information stored in the laptop computer 200 under the control of the controller 160. Before displaying the lists of information, the display unit 120 may display an image or icon corresponding to a communication mode where it transmits/receives a signal to/from the laptop computer 200 until the controller 160 detects the information stored in the laptop computer 200. If an external device is removed from the connector unit 140, the display unit 120 can output an image or an alarm sound to indicate the separation of the external device. It is preferable that the output of an image or an alarm sound is temporarily activated.

The memory 130 stores an operating system for booting the portable terminal. The memory 130 also stores application programs for a variety of functions, such as a file reproducing function, a camera function, a broadcast viewing function, etc. The memory 130 stores user data, generated as the portable terminal 100 is operated, data received through the communication channel, etc. To this end, the memory 130 is configured to include a program storage area and a data storage area.

The program storage area stores application programs related to the functions described above and also a variety of application programs for supporting external devices. For example, one of the application programs is to support a communication mode that performs an automatic plug-in connection when the laptop computer 200 as an external device is connected to the portable terminal 100 and allows the portable terminal 100 to perform data communication therewith. The portable terminal 100 may receive the application program from the portable terminal 100 and store it in the program storage area.

The data storage area stores data generated while the portable terminal 100 is operated. Examples are user data related to a variety of optional functions and information corresponding to the user data. The user data includes images and moving images captured by a camera of the portable terminal 100, phonebook data, audio data, etc. In the embodiment of the present invention, the data storage area may store a variety of information transmitted from the laptop computer 200, such as contents, if the laptop computer 200 is connected to the connector unit 140 of the portable terminal 100.

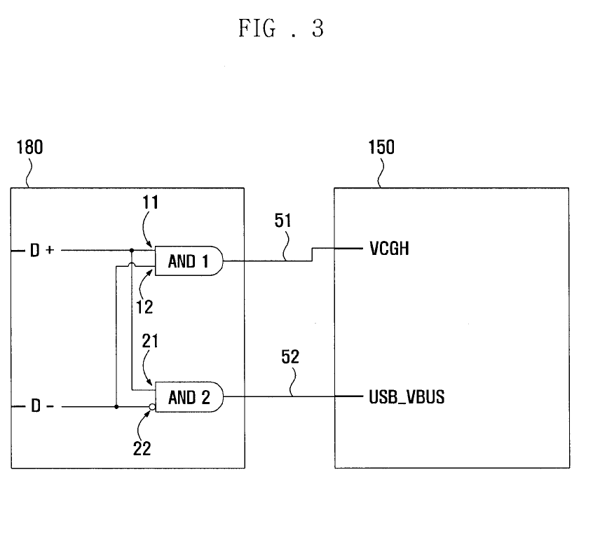

The connector unit 140 is connected with a power cable of the travel adaptor 300 and a communication cable of the laptop computer 200. It is preferable that the connector unit 140 is connected with a modular connector of the cables. To this end, the connector unit 140 may include a connecting terminal having pins connected to the modular connector of the cables. The connector unit 140 may further include a structure that stably fixes the modular connector of the cable to the connecting terminal thereof. If the modular connector is formed as a type of hook, the connector unit 140 is structured to provide a passage for receiving the hook and a protrusion to stably lock the received hook. It should be understood that the structure of the connector unit 140 may be modified according to the different types of portable terminals, the purpose of portable terminal designer, the versions of the portable terminals, etc. For example, the connector unit 140 may be configured to include four connecting terminals for USB communication. In an embodiment of the present invention, the connector unit 140 may include a connecting gate 180 for generating interrupts according to the types of connected external devices. The connecting gate 180 will be explained in detail with reference to FIG. 3.

The battery 170 supplies electric power to each element of the portable terminal 100. It is preferable that the battery 170 be implemented with a secondary battery and a chemical battery, etc., that is rechargeable. In an embodiment of the present invention, the battery 170 is recharged from the travel adaptor 300 under the control of the controller 160.

The controller 160 controls the entire operation of the portable terminal 100. The controller 160 also controls the signal flow among the elements within the portable terminal 100. The controller 160 includes a power management IC 150. In an embodiment of the present invention, the controller 160 controls the signal flow among the connected external device, the power management IC 150, the battery 170, and other elements therein.

The power management IC 150 identifies a type of connected external device according to an interrupt signal transmitted from the connecting gate 180 of the connector unit 140 and performs an operation corresponding to the identified type of external device.

If the travel adaptor 300 serving as an external device is connected to the portable terminal 100, the power management IC 150 receives a charge interrupt from the connecting gate 180. After that, the power management IC 150 supplies electric power from the travel adaptor 300 to the battery 170 through the controller 160 or directly supplies it to the battery 170. The power management IC 150 can control the amount of electric current flowing from the travel adaptor 300 to the battery 170. That is, the power management IC 150 controls the amount of electric current flowing out from the travel adaptor 300 according to the remaining amount of the battery 170 and then recharges the battery with the controlled electric current. If the remaining amount of the battery 170 has almost run out, the power management IC 150 recharges the battery 170 with the maximum amount of electric current. If the remaining amount of the battery 170 is equal to or greater than a certain value, the power management IC 150 starts to recharge the battery 170 with an amount of electric current according to the detected remaining amount of the battery 170 and then gradually reduces the amount of electric current to recharge the battery 170 as the charging amount of the battery 170 is increased.

If a communication device serving as an external device, such as a laptop computer 200, is connected to the portable terminal 100, the power management IC 150 receives a communication interrupt command from the connecting gate 180 and then reports it to the controller 160. The controller 160 the data communication with the connected laptop computer 200 based on the interrupt command. The configurations of the connecting gate 180 and power management IC 150 are explained in detail with reference to FIG. 3.

FIG. 3 is a detailed view illustrating a connecting gate 180 and a power management IC 150 according to an embodiment of the present invention.

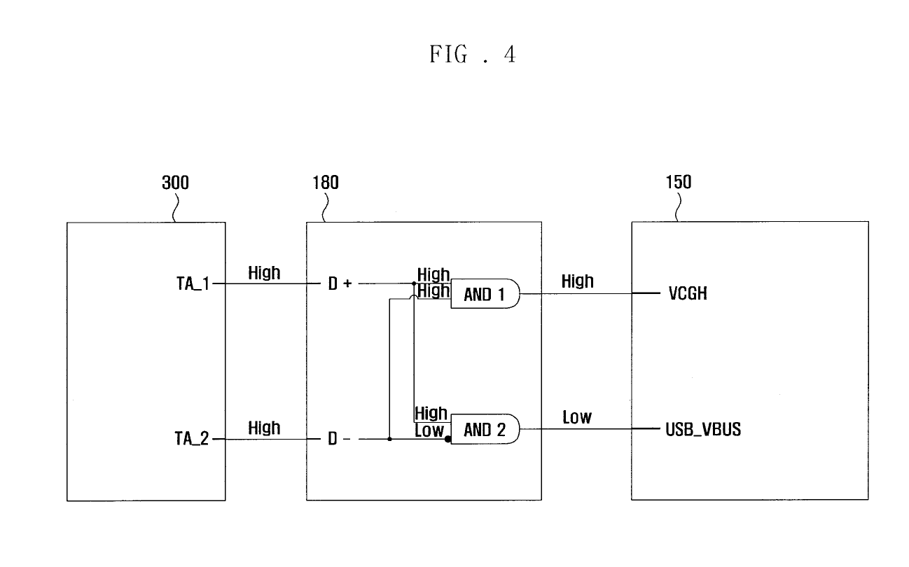

Referring to FIG. 3, the connecting gate 180 includes a first data terminal D+, a second data terminal D−, a first AND gate AND1, and a second AND gate AND2. The first and second data terminals D+ and D− allow for the connection of external device, for example, a travel adaptor and a laptop computer. The first AND gate AND1 receives inputs of the first and second data terminals D+ and D−, respectively, and outputs a signal of ‘High’ level if both the inputs are high. The second AND gate AND2 receives an input of the first terminal D+ and an inverted input of the second data terminal D−, respectively, and outputs a signal of ‘High’ level if the input of the first terminal D+ is High and the inverted input of the second data terminal D− is also High. Therefore, if the connecting gate 180 has both High level inputs of the first and second data terminals D+ and D−, the first AND gate AND1 outputs a signal of ‘High’ level, however, the second AND gate AND2 outputs a signal of ‘Low’ level. Alternatively, if the connecting gate 180 has a High level input of the first data terminal D+ and a ‘Low’ level input of the second data terminals D−, the first AND gate AND1 outputs a signal of ‘Low’ level, however, the second AND gate AND2 outputs a signal of ‘High’ level. A detailed description is provided regarding the logic states of terminals according to different type of external devices connected thereto with reference to FIG. 4.

The power management IC 150 includes a first port VCHG for receiving the output of the first AND gate AND1 and a second port USB_VBUS for receiving the output of the second AND gate AND2. The first port VCHG receives a charge interrupt signal and the second port USB_VBUS receives a communication interrupt signal.

The portable terminal 100 may include first and second lines 51 and 52 for connecting the outputs of the first and second AND gates AND1 and AND2 of the connecting gate 180 and the first and second ports VCHG and USB_VBUS of the power management IC 150, respectively. The first and second connecting lines 51 and 52 may be included in the connecting gate 180 or the power management IC 150.

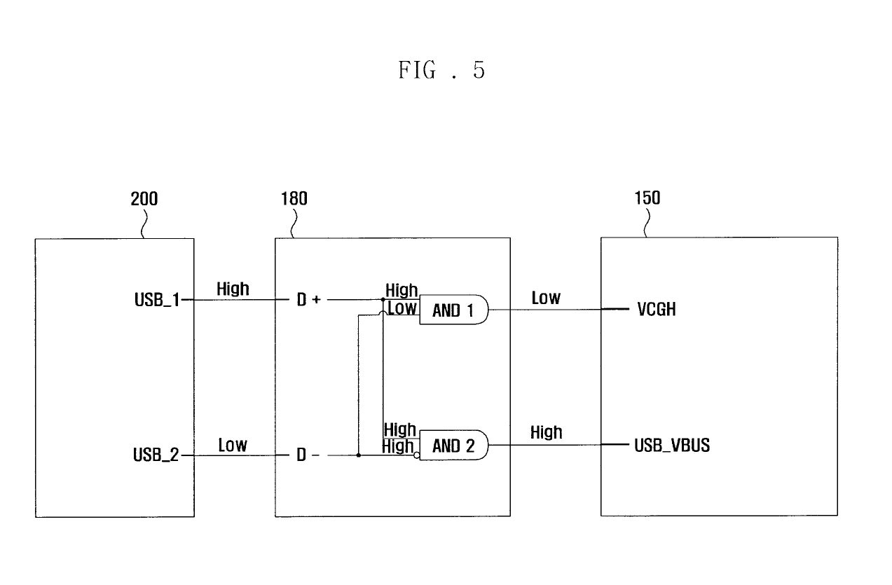

A detailed description is provided regarding signal output states and interrupts receiving states according to the external devices, for example, the travel adaptor 300 or laptop computer 200, with reference to FIGS. 4 and 5.

FIG. 4 is a view that describes a signal flow when a travel adapter is connected to the portable terminal according to an embodiment of the present invention.

Referring to FIG. 4, when the travel adaptor 300 is connected to the connector unit 140, high voltage, i.e., charging electric power of a High level, is supplied from the first and second signal lines TA_1 and TA_2 of the travel adaptor 300 to the first and second data terminals D+ and D− of the connecting gate 180. The signal of High level, received by to the first data terminal D+, is input, as a ‘High level signal’, to a first input lead 11 of the first AND gate AND1 and to a first input lead 21 of the second AND gate AND2. Similarly, the signal of High level, received by the second data terminal D−, is input, as a High level signal, to a second input lead 12 of the first AND gate AND1 and, as a ‘Low level signal’, to the second inverted input lead 22 of the second AND gate AND2.

Therefore, the first AND gate AND1 inputs both ‘High level signals’ and thus outputs a ‘High level signal’ to the first port VCHG of the power management IC 150. The power management IC 150 generates a charging interrupt according to the received ‘High level signal’, and then performs a recharging operation. That is, the power management IC 150 supplies electric power from the travel adaptor 300 to each element of the portable terminal 100 or recharges the battery 170.

Similarly, the second AND gate AND2 inputs a ‘High level signal’ and a ‘Low level signal’ and thus outputs a ‘Low level signal’ to the second port USB_VBUS of the power management IC 150. Since the power management IC 150 does not receive a signal from the second port USB_VBUS, it does not perform an operation.

FIG. 5 is a view that describes a signal flow when a communication device is connected to the portable terminal according to an embodiment of the present invention. In the embodiment of the present invention, a laptop computer is connected to the connecting gate of the connector unit of the portable terminal for illustrative purpose.

Referring to FIG. 5, when the laptop computer 200 is connected to the connector unit 140, high voltage for communication, i.e., a signal of High level, is supplied from the first signal line USB_1 of the laptop computer 200 to the first data terminal D+ of the connecting gate 180, and simultaneously, low voltage for communication, i.e., a signal of Low level, is supplied from the second signal line USB_2 of the laptop computer 200 to the second data terminal D− of the connecting gate 180.

The signal of High level, received by to the first data terminal D+, is input, as a ‘High level signal’, to a first input lead 11 of the first AND gate AND1 and, as a ‘High level signal’, to a first input lead 21 of the second AND gate AND2. Similarly, the signal of Low level, received by the second data terminal D−, is input, as a Low level signal, to a second input lead 12 of the first AND gate AND1 and, as a ‘High level signal’, to the second inverted input lead 22 of the second AND gate AND2.

Therefore, the first AND gate AND1 receives the ‘High level signal’ via the first input lead 11 and the ‘Low level signal’ via the second input lead 12 and thus outputs a ‘Low level signal’ to the first port VCHG of the power management IC 150. Since the power management IC 150 does not receive a signal from the first port VCHG, it does not perform an operation.

On the contrary, the second AND gate AND2 receives both ‘High level signals’ via the first and second input leads 21 and 22 and thus outputs a ‘High level signal’ to the second port USB_VBUS of the power management IC 150. The power management IC 150 generates a communication interrupt according to the received ‘High level signal’, and then performs a controlling operation of the portable terminal 100, for example, transmission or reception of preset dummy data or information regarding the external device.

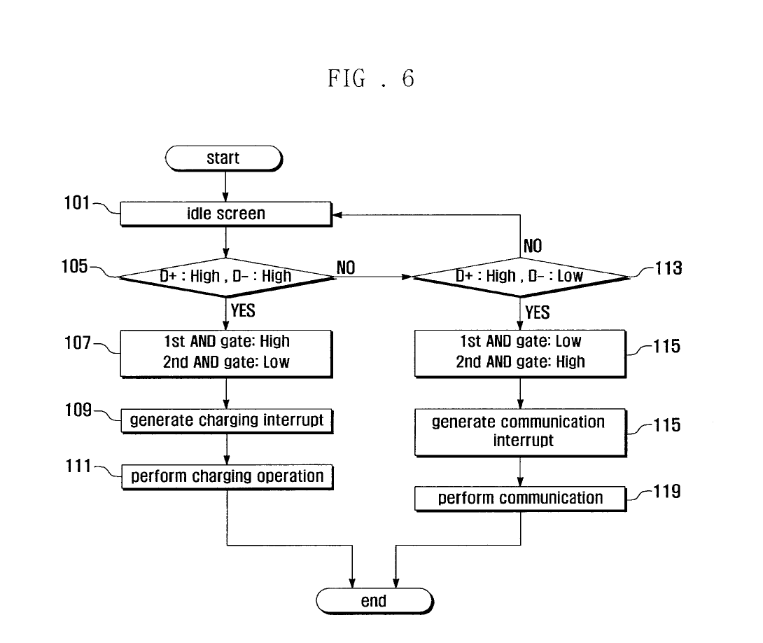

Now, a description is explained in detail regarding the method of controlling interrupts with reference to FIG. 6.

FIG. 6 is a flow chart that describes a method for controlling interrupts of the portable terminal according to an embodiment of the present invention.

Referring to FIG. 6, when the controller ascertains that an input signal for power supply is input to an input unit of the portable terminal, it supplies electric power to each element in the portable terminal, activates an application program and boots the portable terminal. After the portable terminal has been booted, the controller displays a preset idle screen on the display unit (101).

After that, the controller determines whether the connecting gate of the connector unit receives a ‘High level signal’ via its first and second data terminals D+ and D−, respectively, (105).

If the controller ascertains that the connecting gate receives a ‘High level signal’ via its first and second data terminals D+ and D−, respectively, at 105, it inputs the High level signal to the first and second AND gates of the connecting gate. The connecting gate receives the High level signal via the first input lead 11 and the second input lead 21 of the first AND gate, so that it outputs a High level signal to the power management IC, and receives the High level signal via the first input lead 21 of the second AND gate and the Low level signal via the inverted second input lead 22 of the second AND gate, so that it outputs a ‘Low level signal to the power management IC (107).

The High level signal of the first AND gate is transmitted to the first port of the power management IC, related to the charge interrupt mode, and the Low level signal of the second AND gate is transmitted to the second port of the power management IC, related to the communication interrupt mode. Therefore, the power management IC generates a charge interrupt command according to the High level signal transmitted from the first AND gate (109).

After that, the power management IC performs a charging operation (111). The power management IC does not generate a communication interrupt but performs a controlling operation to charge the battery with electric power from the travel adaptor or to supply electric power to the portable terminal.

On the contrary, if the controller ascertains that the connecting gate receives a ‘High level signal’ via its first and second data terminals D+ and D−, respectively, at 105, it determines whether a ‘High level signal’ is input to the first data terminal D+ and a ‘Low level signal’ is input to the second data terminal D− (113).

If the controller ascertains that the first and second data terminals do not receive a signal at 113, where a ‘Low level signal’ is input to the first data terminal D+ and a ‘Low level signal’ is input to the second data terminal D−, it returns to and proceeds with step 101.

On the contrary, the controller ascertains that a ‘High level signal’ is input to the first data terminal D+ and a ‘Low level signal’ is input to the second data terminal D− at 113, it inputs the High level signal to the first AND gate of the connecting gate and the Low level signal to the second AND gate. The connecting gate receives the High and Low level signals via the first and second input leads 11 and 12 of the first AND gate, respectively, so that it outputs a Low level signal to the power management IC, and receives the High level signal via the first and second input leads 21 and 22 of the second AND gate, respectively, so that it outputs a ‘High level signal to the power management IC (115).

The Low level signal of the first AND gate is transmitted to the first port of the power management IC, related to the charge interrupt. The High level signal of the second AND gate is transmitted to the second port of the power management IC, related to the communication interrupt. Therefore, the power management IC generates a communication interrupt according to the High level signal transmitted from the second AND gate (117).

The controller performs communication with the laptop computer connected to the connector unit according to the generated communication interrupt (119).

In the embodiment of the present invention, although the second AND gate is implemented in such a way that its second input lead 22 includes an inverter so that it can invert the input of the second data terminal D− and receives the inverted input, it should be understood that the present invention is not limited to the embodiment. The embodiment may be modified in such a way that the first input lead 21 and the output lead of the second AND gate include an inverter instead of removing the inverter from the second input lead 22. It will be appreciated that the connecting gate can be modified with a variety of gates.

As described above, the method and apparatus, according to the present invention, can control the signals that will be input to the power management IC, according to the levels of the signals input to the first and second data terminals of the connecting gate, so that it can generate only corresponding interrupts but avoids generating unnecessary interrupts.

As described above, the method and apparatus, according to the present invention, can generate a necessary interrupt in a portable terminal according to types of external devices, thereby reducing the load of the portable terminal and smoothly controlling the connected external device.

Although exemplary embodiments of the present invention have been described in detail hereinabove, it should be understood that many variations and modifications of the basic inventive concept herein described, which may be apparent to those skilled in the art, will still fall within the spirit and scope of the exemplary embodiments of the present invention as defined in the appended claims.

What is claimed is:

1. An apparatus for controlling interrupts in a portable terminal, comprising:
a connector unit detachably coupled to an adaptor for supplying an electric power or detachably coupled to a communication device for supplying a communication electric power;
a connecting gate for generating an output signal according to the charging electric power or the communication electric power; and
a power management IC for generating a charging interrupt signal or a communication interrupt signal according to the generated output signal.

2. The apparatus of claim 1, wherein the connecting gate comprises:
first and second data terminals for supplying the electric power of the communication electric power; and
first and second gates for receiving signals of the first and second data terminals, respectively.

3. The apparatus of claim 2, wherein the power management IC comprises:
a first port for generating the charging interrupt signal according to an output signal of the first gate; and
a second port for generating the communication interrupt signal according to an output signal of the second gate.

4. The apparatus of claim 3, wherein the first gate outputs a High level signal to the first port of the power management IC if the electric power is supplied to the connecting gate, and outputs a Low level signal to the second port of the power management IC if the communication electric power is supplied to the connecting gate.

5. The apparatus of claim 3, wherein the second gate outputs a Low level signal to the first port of the power management IC if the electric power is supplied to the connecting gate, and outputs a High level signal to the second port of the power management IC if the communication electric power is supplied to the connecting gate.

6. The apparatus of claim 2, wherein the first gate comprises:
a first input lead for receiving an input signal of the first data terminal; and
a second input lead for receiving an input signal of the second data terminal.

7. The apparatus of claim 2, wherein the second gate comprises:
a first input lead for receiving an input signal of the first data terminal; and
a second inverting input lead for receiving an inverted input signal of the second data terminal.

8. A method for controlling modes in a portable terminal comprising:
coupling a travel adaptor for supplying an electric power or a communication device for supplying a communication electric power to a connector unit of the portable terminal;
generating an output signal in a connecting gate according to the charging electric power or the communication electric power; and
generating a charging interrupt signal or a communication interrupt signal in a power management IC according to the generated output signal.

9. The method of claim 8, wherein, if the electric power is supplied to the connecting gate, generating an output signal comprises:
outputting a High level signal from the connecting gate to a first port of the power management IC, which generates the charging interrupt signal; and
outputting a Low level signal from the connecting gate to a second port of the power management IC, which generates the communication interrupt signal.

10. The method of claim 8, wherein, if the electric power is supplied to the connecting gate, generating an output signal comprises:
outputting a Low level signal from the connecting gate to a first port of the power management IC, which generates the charging interrupt signal; and
outputting a High level signal from the connecting gate to a second port of the power management IC, which generates the communication interrupt signal.
